(19) United States
(12) Patent Application Publication
(10) Pub. No.: US 2008/0284828 A1
(43) Pub. Date: Nov. 20, 2008

(54) Ink ejection system with separated ink tank and printing head

(75) Inventors: Shr-How Haung, Taoyuan County (TW); Wen-Chen Liu, Taoyuan County (TW); Ming-Chung Peng, Taoyuan County (TW); Cheng-Ju Lee, Taoyuan County (TW)

Correspondence Address: BIRCH STEWART KOLASCH & BIRCH, PO BOX 747, FALLS CHURCH, VA, 22040-0747, US

(73) Assignee: Qisda Corporation

(21) Appl. No.: 12/153,239

(22) Filed: May 15, 2008

(30) Foreign Application Priority Data
May 15, 2007 (TW) 96117276

(51) Int. Cl. B41J 29/38

(52) U.S. Cl. 347/85

(57) ABSTRACT

An ink ejection system with a print head and an ink priming station is provided. The ink reservoir of the print head has a plurality of ink channels, a plurality of ball valves, a plurality of storing areas, and a plurality of priming holes. Each of the ball valves is located at an outlet of the respective ink channel and has a floating ball. The plurality of storing areas is aligned to the plurality of ink channels respectively for storing ink of different colors. The plurality of priming holes, which are located on a surface of the ink reservoir, is connected with the respective storing areas for balancing air pressure between interior of the ink reservoir and environment. As ink in the storing area excesses a predetermined height, the respective floating ball closes the respective ball valve to stop injecting ink to the respective storing area. The ink priming station has an air cover linked to a pump. As the print head is stationed on the ink priming station, the air cover covers the priming holes to have the interior of the ink reservoir showing negative pressure.

### BACKGROUND OF THE INVENTION

(1) Field of the Invention

This invention relates to an ink ejection system and a print head thereof, and more particularly relates to an ink ejection system with separated ink tank and print head.

(2) Description of the Prior Art

An inkjet printer features an ink ejection system including an ink tank and a print head. The ink ejected from the print head is provided by the ink tank. The traditional disposable-designed ink tank incorporates a print head thereon. In contrast with the other structures of the ink tank, the print head is expensive but durable. However, as the ink tank is exhausted, the print head must be thrown away together with the exhausted ink tank even the print head is still operational. Thus, the design of integrated print head and ink tank may increase the fabrication cost and result in a waste to dispose the still-operational print head. In order to solve this problem, various designs of separated print head and ink tank have been developed.

As to the inkjet printer with separated print head and ink tank, the print head thereof usually has a reservoir therein for temporarily storing the ink from the ink tank. In order to have the ink in the reservoir successively ejected from the print head, the interior of the reservoir must be communicated with the environment. However, as the reservoir is exhausted, in order to prime the ink within the ink tank to the exhausted reservoir, the interior of the reservoir must be isolated from the environment.

In order to fulfill the two above mentioned functions, the inkjet printer in present usually has a design of independent air pressure balance device and prime valve. The air pressure balance device is utilized to have the ink in the reservoir successively ejected from the print head. The prime valve is utilized to enable the ink in the ink tank injecting to the reservoir. The air pressure balance device usually has a pressure balance valve for balancing the air pressure between the interior of the ink tank and the environment. However, the assembly of the air pressure balance device and the prime valve complicates the structure of the ink tank and makes the size unshrinkable.

When printing, the pressure balance valve of the air pressure balance device is kept open to have the ink in the reservoir successively ejected from the print head. Whereas, when priming ink from the ink tank to the reservoir, the pressure balance valve must be closed by using an additional mechanism formed on the carrier of the print head to control the operation of the pressure balance valve.

In addition, the ink tank usually has a plurality of storing areas therein for storing ink of different colors. Because the consumption rates of ink of different colors are different, a plurality of independently controlled pressure balance valves must be used for selectively priming ink of different colors. That is, each pressure balance valve needs a respective mechanism to control the operation of the valve. These mechanisms increase the weight and size of the carrier of the print head, which not only increase power consumption of driving motor but also influence the precision of positioning the print head.

Accordingly, the present invention focuses on the problem due to the complicated designed print head and carrier of the traditional ink ejection and provides a resolution to reduce the weight and size of the print head and the carrier.

### SUMMARY OF THE INVENTION

It is a main object of the present invention to simplify the design of traditional ink ejection device with separated print head and ink tank, especially focuses on replacing the air pressure balance device and the priming device of traditional design, so as to reduce the size and fabrication cost of the print head and enhance positioning precision of print head.

It is another object of the present invention to have the reservoir capable of priming ink of one specific color or all colors without the need of using a complicated print head and carrier.

An ink ejection system is provided in the present invention. The ink ejection system has a print head and an ink priming station. The ink head has an ink reservoir. The ink reservoir has a plurality of ink channels, a plurality of ball valves, a plurality of storing areas, and a plurality of priming holes. Wherein, each of the ink channels is corresponding to an ink color. Each of the ball valves has a floating ball and is located at an outlet of the respective ink channel. The plurality of storing areas is aligned to the plurality of ink channels respectively for storing ink of different colors. The plurality of priming holes, which are located on a surface of the ink reservoir, is connected with the respective storing areas for balancing air pressure between interior of the ink reservoir and environment. Wherein as ink in the storing area excesses a predetermined height, the respective floating ball closes the respective ball valve to stop injecting ink to the respective storing area.

The ink priming station is utilized for priming ink to the ink reservoir as the print head is stationed on the ink priming station. The ink priming station has an air cover and a priming control module. The air cover is linked to a pump. As the print head is stationed on the ink priming station, the air cover covers the plurality of priming holes. Through the covered priming holes, the pump has the interior of the ink reservoir showing negative pressure. The priming control module has a cam and a plurality of bars. The plurality of bars is aligned to the plurality of priming holes respectively. A rotational angle of the cam decides which of the bars is moved upward to close the respective priming hole to stop ink of respective color being primed to the reservoir.

### BRIEF DESCRIPTION OF THE DRAWINGS

The present invention will now be specified with reference to its preferred embodiment illustrated in the drawings, in which:

FIG. 1 is a schematic view showing a preferred embodiment of an ink ejection system in the present invention;

FIG. 2 is a schematic view showing a preferred embodiment of an ink reservoir in the present invention;

FIG. 2A is an explosive view of the ink reservoir of FIG. 2;

FIG. 2B is a cross-section view of the ink reservoir of FIG. 2 along a-a direction;

FIG. 2C is a cross-section view showing the ink reservoir of FIG. 2B as the ink in the storing area excesses a predetermined height;

FIG. 3 is a cross-section view of the ink reservoir of FIG. 2 along b-b direction;

FIGS. 4 and 4A are schematic views showing a preferred embodiment of the ink priming station in accordance with the present invention; and

FIGS. 5A and 5B are schematic views showing a preferred embodiment of the ink priming station together with the ink reservoir in accordance with the present invention.

### DESCRIPTION OF THE PREFERRED EMBODIMENT

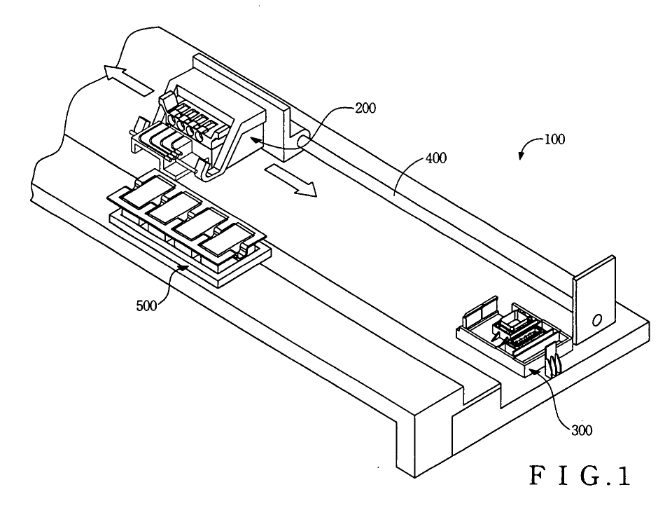

FIG. 1 is a schematic view showing a preferred embodiment of an ink ejection system 100 in the present invention. As shown, the ink ejection system 100 is used in a combination of separated print head 200 and ink tank 500. The ink ejection system 100 also has an ink priming station 300. The print head 200 scans along an axis 400 to eject ink drops on a medium, such as document. The ink priming system 300 is located outside the scanning range of the print head 200. As ink within the ink reservoir of the print head 200 is exhausted, the print head 200 may be moved to the ink priming station 300 along the axis 400 and the ink priming station 300 may inject ink to the ink reservoir of the print head 200 by using a pump (not shown) to suck the ink in the ink tank 500.

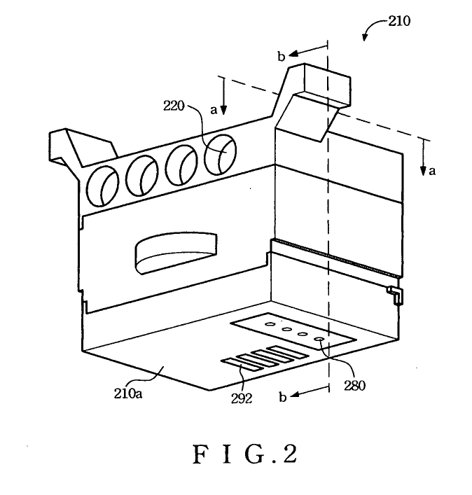

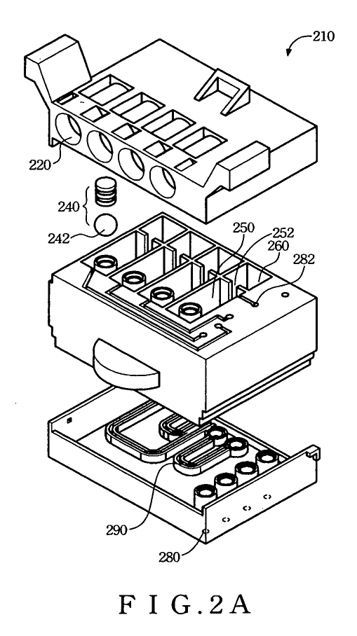

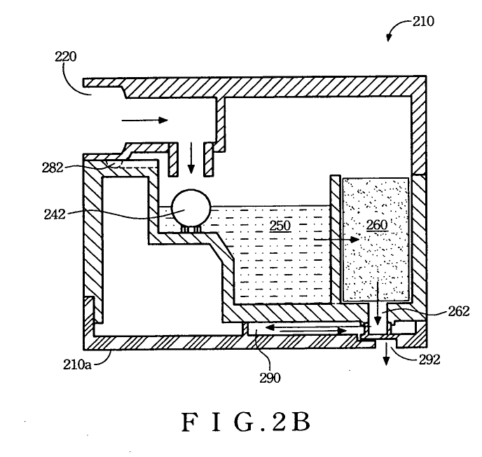

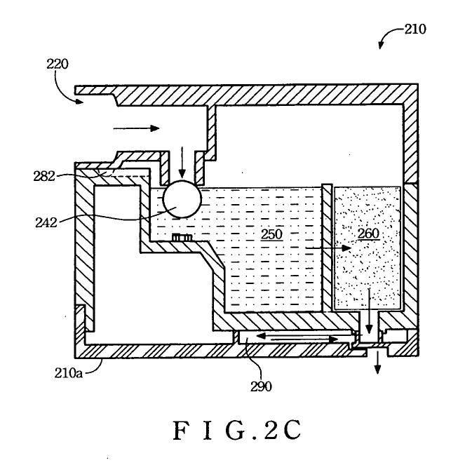

FIG. 2 is a schematic view showing a preferred embodiment of the ink reservoir 210 of the print head 200 in the present invention. FIG. 2A is an explosive view of the ink reservoir 210 of FIG. 2. FIG. 2B is a cross-section view of the ink reservoir 210 along a-a direction. The arrow in this figure indicates the direction of ink flow. As shown, the reservoir 210 has a plurality of ink channels 220, a plurality of ball valves 240 (one ball valve 240 is shown in this figure as an example), a plurality of storing areas 250, a plurality of sponge zones 260, a plurality of priming holes 280, and a plurality of ink ways 290.

As shown in FIG. 2B, ink from the ink tank 500 is injected to the storing area 250 of the reservoir 210 through the ink channel 220. The ink channels 220 shown in FIG. 2 are corresponding to the ink tanks 500 of different ink colors, respectively. The ball valve 240 has a floating ball 242 with gravity smaller than that of the ink. Each of the ball valves 240 is located at an outlet of the respective ink channel 220. The storing areas 250 are aligned to the ink channels 220 respectively for temporarily storing ink of different colors. Also referring to FIG. 2C, as ink in the storing area 250 excesses a predetermined height, the floating ball 242 is lifted by the ink to close the ball valve 240 so as to block the outlet of the ink channel 220 above the storing area 250 and stop injecting (or priming) ink to the storing area 250.

Also referring to FIG. 2A, each of the storing areas 250 has an opening 252 on a sidewall thereof for communicating with the respective sponge zone 260. Each of the sponge zones 260 has an outlet 262 on a bottom surface thereof for connected with the respective ink way 290 for providing ink to the ink ejecting chip (not shown in this figure). Ink drops are ejected by the ink ejecting chip through the ink ejecting holes 292 on a bottom surface 210a of the ink reservoir 210 to the medium.

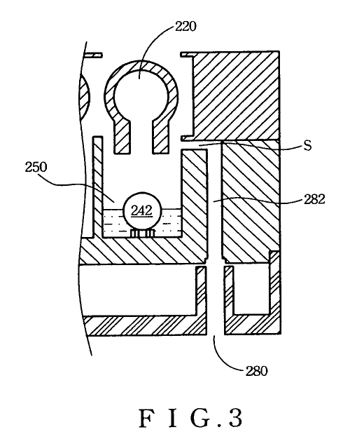

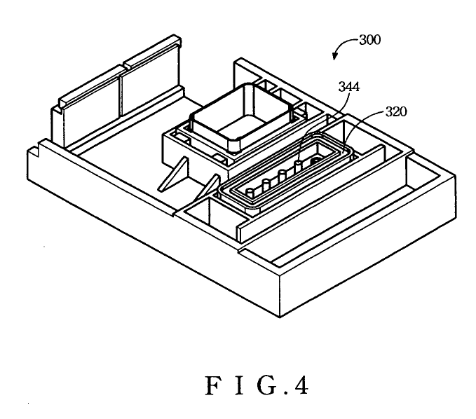

In order to have the ink in the ink tank 500 successively injected to the storing area 250 through the ink channel 220, referring to FIG. 2, the ink reservoir 210 has a plurality of priming holes 280 formed on the bottom surface 210a thereof. Also referring to FIG. 3, which is a cross-section view of the ink reservoir 210 of FIG. 2 along b-b direction, the priming holes 280 located on the bottom surface 210a of the ink reservoir 210 are connected with the respective storing areas 250 through an air channel 282. The air channel 282 has at least a portion S located above the storing area 250. The junction of the air channel 282 and the storing area 250 is also located above the storing area 250. Thereby, the ball valve 240 is capable to prevent ink within the storing area 250 from flowing into the air channel 282 to block the priming holes 280.

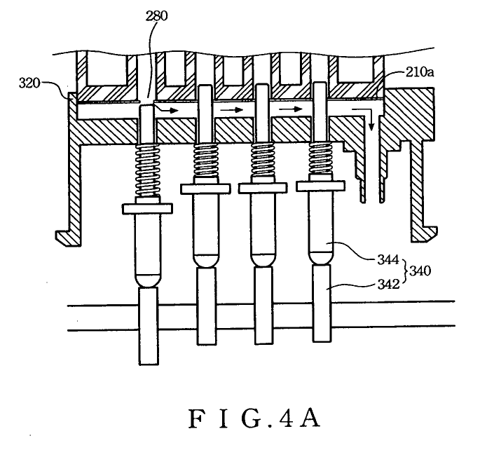

FIG. 4 is a schematic view of a preferred embodiment of the ink priming station 300 in accordance with the present invention. The ink priming station 300 is utilized for priming ink to the ink reservoir 210 as the print head is stationed on the ink priming station 300. As shown, the ink priming station 300 has an air cover 320 linked to a pump (not shown in this figure). As the print head 200 moving along an axis 400 is stationed on the ink priming station 300, the air cover 320 covers at least one of the priming holes 280 on the bottom surface 210a of the ink reservoir 210 so as to have the priming hole 280 connected with the pump. Thereby, the pump may have interior of the ink reservoir 210 showing negative pressure through the covered priming holes 280 and have the ink within the ink tank 500 injected to the ink reservoir 210 through the ink channel 220.

Also referring to FIG. 4A, which is a cross-section view of the ink priming station 300 of FIG. 4. The arrow in this figure indicates air flows as the pump is operated. As shown, the ink priming station 300 also has a priming control module 340 for selectively priming ink or different colors. The priming control module 340 has a cam 342 and a plurality of bars 344 connected to the cam 342. The bars 344 are aligned to the plurality of priming holes 280 on the bottom surface 210a of the ink reservoir 210, respectively. A rotational angle of the cam 342 decides which of the bars 344 is moved upward to close the respective priming hole 280. As the priming hole 280 is closed by the bar 344, ink of respective ink color would not be primed into the respective storing area 250 because the storing area 250 is isolated from the pump and the pump cannot have the storing area showing negative pressure. With the help of the priming control module 340, the ink priming station 300 is capable of selectively priming ink of different colors by controlling the rotation of the cam 342. The problem due to different consumption rates of different ink colors can be resolved.

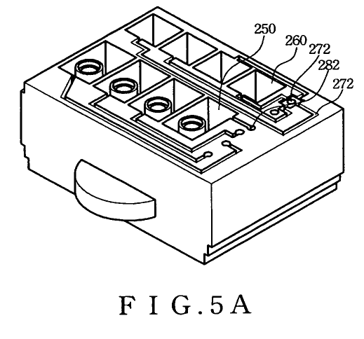

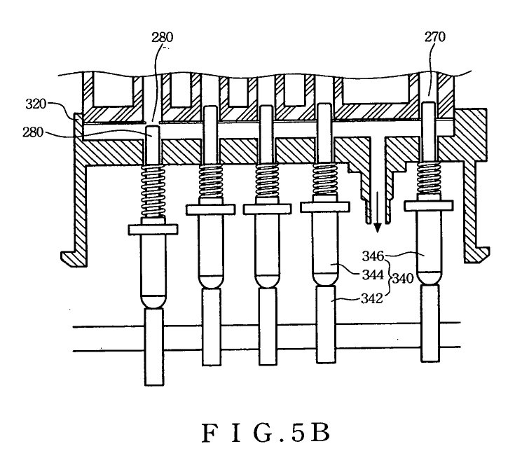

FIGS. 5A and 5B are schematic views of another preferred embodiment of the ink reservoir 210 and the respective ink priming station 300 in the present invention. FIG. 5A only shows the differences between the ink reservoir 210 in FIG. 2A and that of the present embodiment. As shown in FIG. 5B, in addition to the plurality of priming holes 280 formed on the bottom surface 210a of the ink reservoir 210, the ink reservoir 210 in the present embodiment also has an hole 270 for balancing air pressure between interior of the ink reservoir 210 and environment. In contrast with the priming hole 280, which is connected with one respective storing area 250, the hole 270 is connected with each of the storing areas 250 or sponge zones 260 through the air channel 272. Thus, one hole 270 is capable to balance air pressure between different the storing areas 250 and the environment to have ink within the ink reservoir 210 successively ejected on the document. The location of the air channels 272 and 282 are similar. That is, the air channel 272 has at least a portion located above the storing area 250 to prevent ink stored in the storing area 250 from flowing into the air channel 272 to block the air-pressure balance hole 270.

In order to control the condition of the hole 270, referring to FIG. 5B, the priming control module 340 has another bar 346 aligned to the hole 270. The priming control module 340 may control the rotation of the cam 342 to move the bar 346 upward to close the hole 270. It is noted that as the hole 270 is opened, each of the storing areas 250 within the reservoir 210 becomes negative pressure when the pump is pumping no mater if the priming holes 280 are opened or not. Thus, ink of all colors is injected into the ink reservoir 210 until ink in the storing area 250 excesses a predetermined height to close the ball valve 240. As the hole 270 is closed, each storing area 250 is connected with the pump through the respective priming holes 280 and shows a condition similar to that of FIG. 4A.

Referring to FIG. 3, when the ink ejection system needs to print, interior of the ink reservoir 210 is communicated with the environment through the priming holes 280 to have ink drops ejected on the document successively. That is, the priming holes 280 have the function similar to the traditional pressure balance device. Referring to FIGS. 4 and 4a, when ink in the ink reservoir 210 is exhausted, the print head 200 is moved to the ink priming station 300 and the priming holes 280 of the ink reservoir 210 are covered by the air cover 320 and connected with the pump. Thereby, ink within the ink tank 500 can be injected to the ink reservoir 210 without the need of using additional mechanisms to close the pressure-balance valve because the priming holes 280 have been isolated by the air cover 320.

In addition, referring to FIG. 5A, the priming control module 340 of the ink priming station 300 is capable to control the movement of the bars 344 by adjusting the rotational angle of the cam 342 so as to choose which priming hole 280 is to be closed. When the priming hole 280 is closed, ink of respective ink color would not be primed into the ink reservoir 210. Thus, in contrast with the traditional method, which needs a plurality of independently controlled priming valves or independent pumps for selectively priming ink of different colors, the ink priming station 300 of the present invention is capable to selectively priming ink of different colors by using the cam 342 and the bars 344 to control which priming hole 280 is to be closed. Therefore, the complication of the device can be reduced.

Moreover, the ink reservoir 210 of the present invention has ball valves 240 for automatically blocking the respective ink channels 220. As ink within the storing area 250 excesses a predetermined height, the floating ball 242 is lifted by the ink to close the ball valve 240 and the ink cannot be injected into the storing area 250 of the ink reservoir 210. In addition, each of the ink channel 220 has a ball valve 240 formed at the outlet thereof, the ink within the storing area 250 can be kept under a predetermined height without the need of using the priming control system 340 as shown in FIG. 4A. Although ink of different colors is injected toward the respective storing areas 250 at the same time, the ink reservoir 210 of the present invention is capable of selectively priming ink of different colors by using the ball valves 240 to block the respective ink channel 220 as ink within the storing area 250 excesses the predetermined height.

In conclusion, the ink ejection system 100 of the present invention may simplify the design of the traditional ink ejection system with separated ink tank and print head, especially the pressure-balance device and the priming valves. Therefore, the size and the cost of the print head 200 can be reduced and the positioning precision of the print head 200 can be enhanced. In addition, the ink ejection system 100 of the present invention is also capable of selectively priming ink of different colors to meet the need due to the various consumption rates of ink of different colors.

While the preferred embodiments of the present invention have been set forth for the purpose of disclosure, modifications of the disclosed embodiments of the present invention as well as other embodiments thereof may occur to those skilled in the art. Accordingly, the appended claims are intended to cover all embodiments which do not depart from the spirit and scope of the present invention.

I claim:

1. An ink reservoir comprising:
a plurality of ink channels;
a plurality of ball valves, located at an outlet of the respective ink channel, and each of the ball valves having a floating ball;
a plurality of storing areas, aligned to the plurality of ink channels respectively; and
a plurality of priming holes, located on a surface of the ink reservoir, connected to the respective storing areas;
wherein as ink in the storing area excesses a predetermined height, the respective floating ball closing the respective ball valve.

2. The ink reservoir of claim 1, wherein the priming hole is connected with the respective storing area through an air channel.

3. The ink reservoir of claim 2, wherein the air channel is above the storing area.

4. The ink reservoir of claim 2, further comprising a hole on a surface of the ink reservoir, and the hole is connected to the plurality of storing areas.

5. The ink reservoir of claim 4, wherein the hole is connected with the respective storing areas through an air channel.

6. The ink reservoir of claim 5, wherein the air channel is above the storing area.

7. The ink reservoir of claim 6, wherein the ink reservoir is used in a combination of separated print head and ink tank.

8. An ink priming station, utilized for priming ink to an ink reservoir within a print head as the print head being stationed on the ink priming station, the ink reservoir having at least a priming hole on a surface thereof, and the ink priming station comprising:
an air cover, linked to a pump, as the print head stationed on the ink priming station, the air cover covering the priming hole, and through the covered priming hole, the pump having interior of the ink reservoir showing negative pressure.

9. The ink priming station of claim 8, wherein the priming hole is connected with the interior of the ink reservoir.

10. The ink priming station of claim 8, wherein the ink reservoir has a hole on a surface thereof for balancing air pressure between the interior of the ink reservoir and environment.

11. The ink priming station of claim 8, further comprising:
a priming control module, having a cam and a plurality of bars aligned to the plurality of priming holes respectively, a rotational angle of the cam decides which of the bars being moved upward to close the respective priming hole.

12. An ink ejection system comprising:
a print head, having an ink reservoir, the ink reservoir comprising:
a plurality of ink channels;
a plurality of ball valves, each of the ball valves having a floating ball and being located at an outlet of the respective ink channel;
a plurality of storing areas, aligned to the plurality of ink channels respectively; and
a plurality of priming holes, which are located on a surface of the ink reservoir, connected with the respective storing areas for balancing air pressure between interior of the ink reservoir and environment;
wherein as ink in the storing area excesses a predetermined height, the respective floating ball closing the respective ball valve to stop injecting ink to the storing area; and
an ink priming station, utilized for priming ink to the ink reservoir as the print head being stationed on the ink priming station, and the ink priming station comprising:
an air cover, linked to a pump, as the print head is stationed on the ink priming station, the air cover covering the plurality of priming holes to have interior of the ink reservoir showing negative pressure.

13. The ink ejection system of claim 12, wherein the priming hole is connected with the respective storing area through an air channel.

14. The ink ejection system of claim 13, wherein the air channel is above the storing area.

15. The ink ejection system of claim 12, further comprising a hole on a surface of the ink reservoir, and the hole is connected with the plurality of storing areas.

16. The ink ejection system of claim 15, wherein the hole is connected with the storing area through an air channel.

17. The ink ejection system of claim 16, wherein the air channel is above the storing area.

18. The ink ejection system of claim 15, further comprising a plurality of sponge zones connected with the plurality of storing areas respectively, and the hole is connected with the plurality of storing areas through the plurality of sponge zones.

19. The ink ejection system of claim 12, wherein the ink priming station further comprising:
a priming control module, having a cam and a plurality of bars aligned to the plurality of priming holes respectively, a rotational angle of the cam decides which of the bars being upward to close the respective priming hole.
